(19) United States
(12) Patent Application Publication
(10) Pub. No.: US 2016/0082452 A1
(43) Pub. Date: Mar. 24, 2016

(54) SPRAY DEVICE

(71) Applicant: SmartWater Limited, London (GB)

(72) Inventor: Gareth Burke, London (GB)

(73) Assignee: SMARTWATER LIMITED, London (GB)

(21) Appl. No.: 14/859,513

(22) Filed: Sep. 21, 2015

(30) Foreign Application Priority Data
Sep. 19, 2014 (GB) 1416637.5

(51) Int. Cl. B05B 7/24; G08B 15/02; B05B 12/00

(52) U.S. Cl. CPC B05B 7/2421; B05B 12/00; G08B 15/02

(57) ABSTRACT

A spray device is disclosed herein comprising a reservoir having a centre; a gas inlet tube configured to introduce a gas from a gas source into the reservoir, the gas inlet tube having a proximal end for fluid connection to the gas source and a distal end within the reservoir; and outlet configured to release fluid from the reservoir, wherein the gas inlet tube is positioned to direct gas entering the reservoir away from the centre of the reservoir. The spray device may be actuated in response to detection of an event by a sensor. The spray device may spray a unique marker liquid.

### CROSS REFERENCE TO RELATED APPLICATIONS

The subject application claims priority to United Kingdom Patent Application No. 1416637.5 filed Sep. 19, 2014, the contents of which are hereby incorporated herein in their entirety.

### BACKGROUND

Use of markers to deter or detect theft is known. WO 93/07233 discloses a spray containing a fluorescent material that is used to mark products susceptible to theft, or to spray a thief upon activation of a burglar alarm.

It is an object of the present disclosure to provide a spray suitable for use in a security system having improved reliability.

It is a further object of the present disclosure to provide a spray suitable for use in a security system that may be used in a variety of orientations.

It is a yet further object of the present disclosure to provide a spray suitable for use in a security system that occupies a small area or volume.

### SUMMARY OF THE DISCLOSURE

In a first aspect, the present disclosure provides a spray device comprising a reservoir having a centre; a gas inlet tube configured to introduce a gas into the reservoir, the gas inlet tube having a proximal end for connection to a gas source and a distal end within the reservoir; and outlet configured to release fluid from the reservoir, wherein the gas inlet tube is positioned to direct gas entering the reservoir away from the centre of the reservoir.

Optionally, according to the first aspect, the distal end of the gas inlet tube is closer to an internal wall of the reservoir than the centre of the reservoir.

Optionally, according to the first aspect, the gas inlet tube does not lie along a central plane extending across the reservoir. Optionally, the gas inlet tube is offset from and substantially parallel to the central plane. Optionally, the distal end of the gas inlet tube and the outlet are on opposite sides of the central plane.

Optionally, according to the first aspect, the reservoir is substantially cylindrical.

Optionally, according to the first aspect, the outlet is in fluid communication with a nozzle.

Optionally, according to the first aspect, the gas source is a gas canister.

Optionally, according to the first aspect, the device comprises a first bursting disc between an outlet of the gas canister and the proximal end of the gas inlet tube wherein the first bursting disc is configured to burst upon release of gas from the gas canister.

Optionally, according to the first aspect, the device comprises a second bursting disc covering the outlet wherein the second bursting disc is configured to burst upon introduction of gas into the reservoir.

Optionally, according to the first aspect, the gas inlet tube narrows at its distal end.

Optionally, according to the first aspect, the device comprises two plates sealed together to define the reservoir between the plates. Optionally, the or each plate is a plastic material.

In a second aspect, the present disclosure provides a spray device comprising a reservoir; a gas inlet tube configured to introduce gas into the reservoir, the gas inlet tube having a proximal end for connection to a gas source and a distal end within the reservoir; and an outlet configured to release fluid from the reservoir, wherein the gas inlet tube does not lie along a central plane extending across the reservoir.

In a third aspect, the present disclosure provides a spray device comprising a reservoir having a centre; a gas inlet tube configured to introduce gas into the reservoir, the gas inlet tube having a proximal end for connection to a gas source and a distal end within the reservoir; and an outlet configured to release fluid from the reservoir, wherein the distal end of the gas inlet tube is closer to a wall of the reservoir than the centre of the reservoir.

In a fourth aspect, the present disclosure provides a method of spraying a liquid from a spray device according to any preceding claim, the method comprising the step of introducing gas into the reservoir of the spray device and forcing the liquid out of the reservoir outlet.

In a fifth aspect, the present disclosure provides a security system comprising a spray device according to the first or second aspect and a sensor wherein the spray device is configured to spray a liquid from the reservoir in response to detection of an event by the sensor.

The spray device of the second or third aspect have any optional feature described herein with reference to the first aspect.

### DESCRIPTION OF THE DRAWINGS

The apparatus, systems and methods of the present disclosure will now be described in more detail with reference to the drawings in which:

FIG. 1A illustrates a first view of a spray device, according to an embodiment of the present disclosure;

FIG. 1B illustrates a second view of a spray device, according to an embodiment of the present disclosure;

FIG. 1C is a partially exploded view of a spray device, according to an embodiment of the present disclosure; and

FIG. 2 is a schematic illustration of a cylindrical reservoir showing a central plane and central axis of the reservoir, according to an embodiment of the present disclosure.

### DETAILED DESCRIPTION

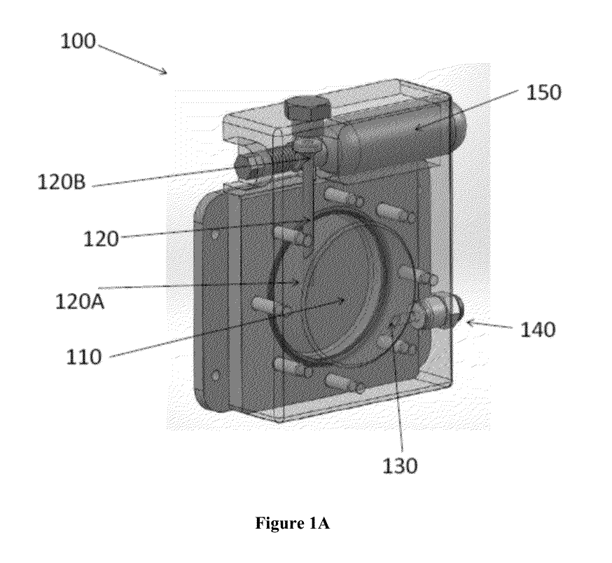

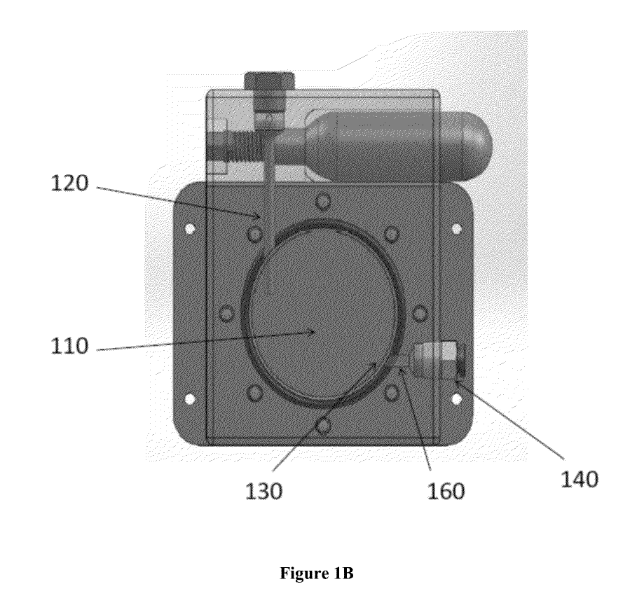

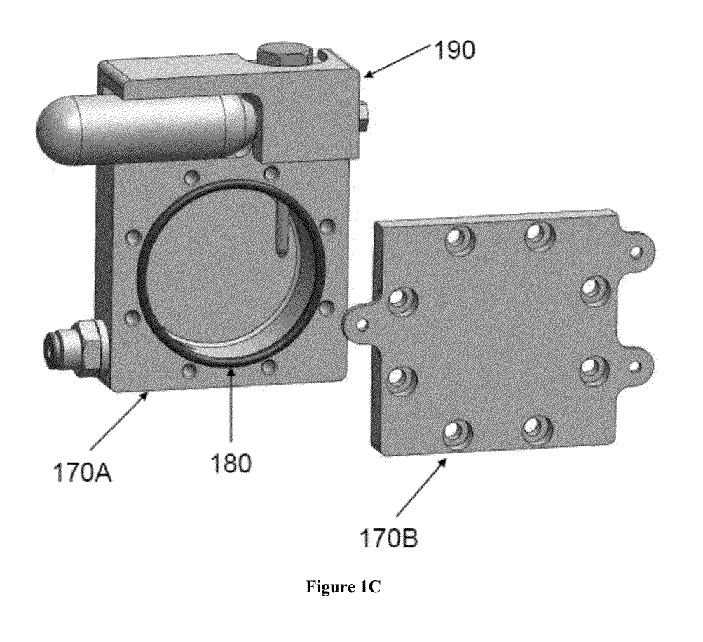

With reference to FIG. 1A a spray device 100 according to an embodiment of the present disclosure may comprise:

a reservoir 110;

a gas inlet guard tube 120 having a proximal end 120B and a distal end 120A and having a gas inlet tube disposed therein;

an outlet 130;

and an outlet from the reservoir 130; and a nozzle 140.

With reference to FIG. 1B, the outlet 130 may be in fluid communication with nozzle 140 through outlet channel 160.

The gas inlet guard tube 120 extends between a gas source 150 and the interior of the reservoir, and extends through a wall of the reservoir 110. The gas inlet guard tube 120 has a gas inlet tube disposed therein. The gas inlet tube has a corresponding proximal end and a distal end. Gas from the gas source may be introduced into the proximal end of the gas inlet tube and introduced into the reservoir from the distal end of the gas inlet tube.

The gas inlet tube may be wholly contained within the gas inlet guard tube 120, or may extend beyond the proximal end 120B and/or distal end 120A of the guard tube.

In other embodiments, the gas inlet tube may be used without a gas inlet guard tube 120.

The reservoir volume may be defined by opposing surfaces with a wall extending between the opposing surfaces. In the embodiment of FIGS. 1A and 1B the wall may be circular, giving a cylindrical reservoir. “Cylinder” as used herein may refer to any three-dimensional object having a circular cross-section.

The gas inlet tube may have a substantially constant diameter. In a preferred embodiment, the distal end of the gas inlet tube has a smaller diameter than the rest of the tube. The outlet 130 may be an aperture in the reservoir wall.

The proximal end of the gas inlet tube may be connected to a gas source. In FIGS. 1A and 1B the gas source may be a pressurised gas canister 150. It will be appreciated that other gas sources may be used. The gas inlet tube extends from its proximal end via the guard tube through the reservoir wall and into the reservoir.

In operation, gas may be introduced from a gas source such as a gas canister 150 as illustrated in FIG. 1. Gas may be introduced into the reservoir 110 from the gas source by manual or automatic operation of a gas release device. Release of gas from the gas source may be achieved in many ways and may be done manually or automatically. Optionally, an electrically operated protractor comprising an explosive charge detonates causing a needle to pierce gas canister 150. This may be in response to an electrical input which may be generated locally or remotely and which may be transmitted to the protractor by a wired or wireless connection.

An increase in pressure in the reservoir 110 caused by introduction of the gas may cause liquid in the reservoir to be expelled through outlet 130, along outlet channel 150 and and through a suitable nozzle 140. The liquid may be sprayed onto one or more objects or individuals within the range of the device 100. The nozzle 140 may be selected according to the desired spray pattern and/or range of the spray.

The liquid may have a single phase, such as a solution, or may be a colloidal suspension, such as a colloidal suspension comprising microparticles. Fluid may be sprayed automatically from the reservoir 110 in response to a signal from a sensor, or manually, it will be understood that a wide range of sensors may be used, and may be selected according to the environment that the spray device is used in and/or the application that the spray device is used for. Exemplary sensors include, without limitation, a motion detector such as, without limitation, a passive infrared detector; a pressure mat; a microwave detector; and an audio detector and the signal may be sent in response to a detection event that trips the sensor, such as detection of motion for a motion sensor. The sensor may be in wired or wireless connection with a spray controller, and occurence of a detection event may be transmitted to the spray controller. The spray controller may be in wired or wireless communication with an actuator configured to release gas from the gas source, for example a protractor, in response to an activation signal from the spray controller.

The spray device may be provided in a portable container, preferably a lockable portable container. The portable container may be a box or case. The portable container may be a cash in transit box. Liquid may be sprayed by the spray device onto contents of the portable container in response to a control signal. The control signal may be sent to a spray actuator in response to an unauthorised opening or attempted opening of the portable container. The control signal may be sent to the spray device automatically or manually and may be sent by a wired or wireless connection. Exemplary automatic control signals include, without limitation: a control signal in response to switching of a pressure release switch provided on the box; and a control signal generated in response to a sensor provided on the box being tripped, for example a proximity sensor.

The motion detector may detect motion within a spray range of the spray 100 such that an individual, who may be a burglar or other intruder, coming into range of the spray 100 is sprayed. In other embodiments, the spray 100 may be activated in response to motion detected inside or outside the spray range of the motion detector such that an object, such as a valuable object vulnerable to theft, is sprayed. The spray may be located in any indoor or outdoor location and may be preferably located in an area of restricted access such as private property or commercial premises. Points at which the spray may be provided include, without limitation, an access passage such as a hallway or on an access point such as a doorway. The spray device 100 can be used in any situation, but may be specifically designed to operate in small spaces and at any orientation. Examples include use inside cash in transit boxes to mark cash in the event that a box is stolen. Likewise it may be used to protect cash inside parking meters or vending machines.

In use, the spray may be used in any orientation including, without limitation, an orientation in which the gas inlet tube is vertically higher the outlet; an orientation in which the gas inlet tube is vertically lower than the the outlet; and an orientation in which the gas inlet tube and the outlet are in the same horizontal plane.

The ability of the device to function at any orientation is advantageous when used in portable containers, such as cash in transit boxes.

The reservoir 110 has a centre and the gas inlet tube may be positioned such that gas entering the reservoir is not directed towards the centre of the reservoir.

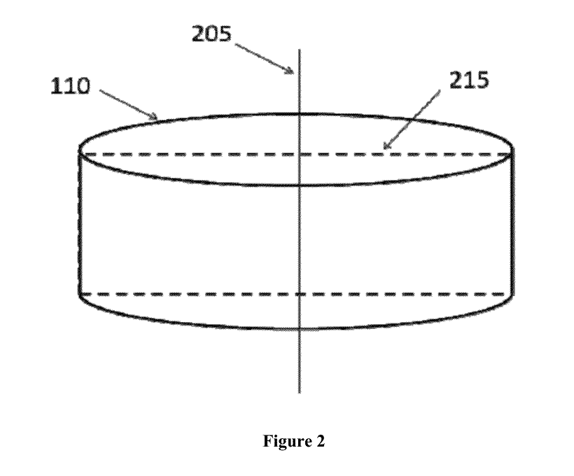

With reference to FIG. 2, the centre of a cylindrical reservoir 110 as illustrated in FIGS. 1A and 1B is a central axis 205 extending through the centre of the cylindrical reservoir.

The reservoir 110 has a central plane 215 extending through the centre of the reservoir. The gas inlet tube may be positioned to direct gas entering the reservoir away from or substantially parallel to the central plane. The gas inlet tube may be offset from and substantially parallel to the central plane of the reservoir. The gas inlet tube may be angled away from the central plane. If a radius is drawn from the centre of the reservoir to the reservoir wall, then the gas inlet tube may be preferably oriented to be perpendicular to this radius and positioned towards the wall and away from the centre of the reservoir so that it does not point towards the centre of the reservoir, It will therefore be understood that gas directed “away from the centre” as used herein may include gas directed substantially perpendicular to a central plane of the reservoir.

According to the present disclosure, positioning the gas inlet tube such that gas entering the reservoir is not directed towards the centre of the reservoir may increase the quantity of liquid that may be ejected from the reservoir as compared to a spray in which the gas is directed to the centre of the reservoir.

According to the present disclosure, directing gas towards the centre of the reservoir may result in substantial differences in the amount of liquid ejected from the reservoir between the cases where the outlet is vertically above, vertically below and in the same horizontal plane as the gas inlet tube, whereas the spray as described herein may eject most or substantially all of the liquid regardless of the orientation of the gas inlet tube and the outlet.

Without wishing to be bound by any theory, gas directed towards the centre of the reservoir may simply exit the reservoir through the outlet without forcing any liquid out of the reservoir whereas directing gas flow towards the wall of the reservoir creates a circular or cyclonic motion of the liquid within the reservoir that may facilitate ejection of liquid from the reservoir.

In the embodiment of FIGS. 1A and 1B and FIG. 2, the reservoir has a circular cross section and the central plane is a diameter of the cylindrical reservoir. The gas inlet tube preferably does not lie along a diameter line of the reservoir.

It will be appreciated that the reservoir may have any shape.

The reservoir may have a circular cross section as illustrated in FIGS. 1A, 1B and 2 or may be an oval.

The cross section of the reservoir may be a regular polygon, for example a square or a regular hexagon.

The cross section of the reservoir may be an irregular polygon with at least one plane of symmetry, for example an oblong.

The cross section may be an irregular polygon with no plane of symmetry.

Preferably, the reservoir may be a cylinder.

If the reservoir has one or more planes of symmetry then each plane of symmetry may define a central plane.

In the case of a reservoir having a cross-section with no plane of symmetry, the central plane may be an area that is the midpoint between opposing walls of the reservoir.

Preferably, the gas inlet tube does not lie along any central plane of the reservoir.

In the case of a reservoir having a plane of symmetry, the centre may be a central axis extending through the reservoir.

In the case of a reservoir having no plane of symmetry, the central axis of the reservoir may be a line extending along the centre of gravity of a notional three-dimensional solid of uniform density having the shape of the reservoir.

The distal end of the gas inlet tube may be preferably closer to the internal wall of the reservoir 100 than a central axis of the reservoir.

The distal end of the gas inlet tube may be preferably remote from the outlet 130. Preferably, the distance between the distal end of the gas inlet tube and the outlet may be preferably at least 60%, optionally at least 70% or at least 80% of the internal width of the reservoir at its widest point (for example, its diameter in the case of a cylindrical reservoir). The distal end of the gas inlet tube and the outlet 130 are preferably on opposite sides of a central plane of the reservoir. In the case of a circular reservoir, the point of the reservoir wall that the gas inlet tube passes through and the outlet are preferably substantially diametrically opposed.

The gas inlet tube and the outlet channel may form an angle of less than 180° , preferably less than 135°. Optionally, the gas outlet and the outlet channel form an angle of about 90°±about 20° or ±about 10°.

The reservoir may have varying dimensions and may have a width at its widest point in the range of about 40-60 mm. The distal end of the gas inlet may be preferably no more than 10-20 mm from an internal surface of the reservoir. The distance between the distal end of the gas inlet and the outlet may be preferably at least 30 mm.

The internal diameter of the gas inlet tube may vary and may be preferably smaller towards the distal end of the gas inlet tube. The internal diameter of the gas inlet tube may be used to control the rate at which gas enters the reservoir.

According to the present disclosure, the rate at which gas is introduced into the reservoir may affect the amount of liquid that is expelled from the reservoir. According to the present disclosure, the rate at which gas is introduced into the reservoir may be selected to avoid significant variations in the quantity of liquid that is expelled from the reservoir at different orientations of the spray.

In one embodiment, the device may comprise a firing mechanism comprising a protractor configured to puncture the gas canister to release gas into the reservoir. According to this embodiment, the reservoir may be separated from fluid communication with the reservoir by a first bursting disc which bursts upon release of gas from the canister to allow the gas to enter the reservoir. The first bursting disc may prevent corrosion of the firing mechanism. The device may comprise a second bursting disc covering the outlet to seal the reservoir and stop liquid exiting via the outlet. When gas is introduced into the reservoir the increase in pressure causes the second bursting disc to burst and the liquid is released.

Suitable gas canisters include sparklet gas bulb holders.

It will be appreciated that a device as described herein may provide virtually instantanous spraying following receipt of a control signal.

The reservoir may be a unitary structure cast or moulded from a single material. The reservoir may be formed from two or more components.

With reference to FIG. 1C, a body of the spray device may be formed by two plates 170A, 170B that define the reservoir when joined together. Plate 170A has a depression formed thereon defining the wall of the reservoir. In another embodiment, both plates may carry a depression to define the wall of the reservoir when the plates are joined together.

The plates 170A, 170B may be secured together by any suitable securing means, for example bolts. An o-ring 180 may be provided between the plates to form a watertight seal.

One plate may contain apertures outside the reservoir area that may be used to secure the spray in position for use, for example on a wall or on a ceiling.

A section 190 of plate 170A may be configured to receive and retain a gas canister.

The components of the spray may individually be formed from any suitable material, for example metal or plastic. The gas inlet guard tube, if present, suitably has a greater strength, for example may be less brittle, than the gas inlet tube, and may be formed from a stronger material than the gas inlet tube.

Low weight components may be used to form the spray. This may be particularly advantageous in the case where the spray is for use in a portable container. One or both of the plates forming the body of the spray device, the gas inlet tube and/or the guard tube may be formed from a plastic material. Exemplary plastics are acetal and reinforced nylon.

The spray device may have a length of no more than about 200 mm, optionally no more than about 150 mm or 100 mm.

The spray device may have a width of no more than about 200 mm, optionally no more than about 150 mm or 100 mm.

The spray device may have a thickness of no more than about 50 mm, optionally no more than about 40 mm or 30 mm.

Preferably, the liquid used in the reservoir may be a marker liquid containing one or more marker materials.

The marker liquid may contain one or more fluorescent or phosphorescent materials. The fluorescent or phosphorescent material or materials will not luminesce in ambient light, but may luminesce under irradiation at specific wavelengths, for example under UV light or other forms of stimulation.

The presence of the fluorescent or phosphorescent material(s) alone may indicate that a person or object has been sprayed, and the fluorescent or phosphorescent material(s) may be the only solutes in the marker liquid.

The liquid preferably contains a marker system. Such marker systems may be based upon different technologies known to the skilled person and it will be appreciated that any such marker system may be used.

The liquid may contain a plurality of different marker compounds and may contain at least two, at least three, at least four, at least five or at least ten, at least twenty different marker compounds. Optionally, the composition may comprise up to forty or up to thirty different marker materials.

The liquid may contain dna based marker.

The liquid may contain microparticle markers.

Each marker compound can be identified using known analytical techniques including, without limitation, spectroscopic and chromatographic techniques, for example mass spectrometry, atomic emission spectroscopy, atomic absorption spectroscopy, LA-ICP-MS; x-ray fluorescence spectroscopy; laser induced breakdown spectroscopy, gas chromatography; PCR; and gel electrophoresis.

A unique marker composition may be formed by varying parameters including, without limitation, identity of a marker; combination of different marker compounds; dna sequencing, concentration of an individual marker within the composition; and relative concentrations of two marker compounds.

In some cases the greater the number of marker compounds used, the greater the number of unique combinations available for use. Furthermore, a greater number of marker materials in a composition may provide a greater degree of certainty in identification of the source of the composition.

A marker liquid may be formed as described in UK Patent GB 2413674, the contents of which are hereby incorporated herein in their entirety. The unique combinations of marker compounds can be prepared using a binary method; however other methods comprising octal and hexadecimal strings can also be used. Each marker liquid may be held on a database of forensic codes and assigned to a specific owner and/or location. With this database, forensic analysis of a marker residue on a person or object can be used to identify the owner of a marked object or the location at which the spraying occurred.

Preferably, each Marker may be an uncommon material to the field of use provided at a concentration that would not normally be present in the field of use. Exemplary marker materials are metal compounds and organic compounds, dna.

Exemplary metals of metal compound markers include, d-block metals, lanthanides, for example lanthanum, Europium and Holmium; and p-block metals, for example Tellurium and Gallium.

Exemplary organic marker compounds include tetrahydrocarbazole derivatives and methoxybenzonitrile derivatives.

Exemplary metal compound markers include metal oxides, metal triflates, metal halides and metal sulphates.

The liquid may comprise a fluorescent or phosphorescent material as an initial indicator and a marker system of one or more materials as described above for specific identification of the source of the marker.

Preferably, the liquid may be a solution or suspension in which water is a solvent or is the only solvent. “Solvent” as used herein may include the liquid component of a suspension.

The gas may be, without limitation, carbon dioxide, nitrogen or air, Preferably the gas may be carbon dioxide.

### EXAMPLES

### Comparative Device 1

A device was prepared as illustrated in FIGS. 1A and 1B except that the gas inlet tube was aligned with a diameter of the reservoir such that gas was directed to the centre of the reservoir.

It was found that the orientation of the spray affected the quantity of liquid ejected from the reservoir.

If the unit was fired with the gas introduction at the top and the liquid outlet at the bottom then more successful firings were achieved:

In a vertical orientation with the gas inlet tube vertically above the outlet, 90% of the liquid was ejected.

In a horizontal orientation 70% of the liquid was ejected.

In a vertical orientation with the gas inlet tube vertically below the outlet 30% of the liquid was ejected.

Device Example 1

A device was formed as illustrated in FIGS. 1A and 1B.

Several repeat firings were undertaken and the results were averaged, Greater than 95% of the volume of the liquid was ejected from the reservoir, regardless of the vertical or horizontal orientation of the inlet relative to the outlet.

The spray has been described herein for marking and detection of goods and/or individuals that have been sprayed by the spray to deter or detect theft, however the spray as described herein may be used for other applications.

Although the apparatus, systems and methods of the present disclosure have been described in terms of specific exemplary embodiments, it will be appreciated that various modifications, alterations and/or combinations of features disclosed herein will be apparent to those skilled in the art without departing from the scope of the invention as set forth in the claims.

1. A spray device comprising a reservoir having a centre; a gas inlet tube configured to introduce a gas from a gas source into the reservoir, the gas inlet tube having a proximal end for fluid connection to the gas source and a distal end within the reservoir; and outlet configured to release fluid from the reservoir, wherein the gas inlet tube is positioned to direct gas entering the reservoir away from the centre of the reservoir.

2. A spray device according to claim 1 wherein the distal end of the gas inlet tube is closer to an internal wall of the reservoir than the centre of the reservoir.

3. The spray device according to claim 1 wherein the gas inlet tube does not lie along a central plane extending across the reservoir.

4. The spray device according to claim 3 wherein the gas inlet tube is offset from and substantially parallel to the central plane.

5. The spray device according to claim 3 wherein the distal end of the gas inlet tube and the outlet are on opposite sides of the central plane.

6. (canceled)

7. (canceled)

8. The spray device according to claim 1 wherein the gas source is a gas canister.

9. The spray device according to claim 8 comprising a first bursting disc between an outlet of the gas canister and the proximal end of the gas inlet tube wherein the first bursting disc is configured to burst upon release of gas from the gas canister.

10. The spray device according to claim 8 comprising a second bursting disc covering the outlet wherein the second bursting disc is configured to burst upon introduction of gas into the reservoir.

11. The spray device according to claim 1 wherein the gas inlet tube narrows at its distal end.

12. The spray device according to claim 1 wherein the device comprises two plates sealed together to define the reservoir between the plates.

13. (canceled)

14. A spray device comprising a reservoir; a gas inlet tube configured to introduce gas into the reservoir, the gas inlet tube having a proximal end for fluid connection to a gas source and a distal end within the reservoir; and an outlet configured to release fluid from the reservoir, wherein the gas inlet tube does not lie along a central plane extending across the reservoir.

15. A spray device comprising a reservoir having a centre; a gas inlet tube configured to introduce gas into the reservoir, the gas inlet tube having a proximal end for fluid connection to a gas source and a distal end within the reservoir; and an outlet configured to release fluid from the reservoir, wherein the distal end of the gas inlet tube is closer to a wall of the reservoir than the centre of the reservoir.

16. The spray device according to claim 1 wherein the spray is activated by a signal from a sensor.

17. The spray device according to claim 16 wherein the sensor is selected from a motion detector; a pressure mat; a microwave detector; and an audio detector.

18. The spray device according to claim 1 wherein the spray device is configured to operate in response to an automated signal.

19. The spray device according to claim 18 wherein the automated signal is generated by a controller remote from the spray device.

20. The spray device according claims 1 wherein the device is configured to operate in response to a signal from a manually operated control.

21. The spray device according to claim 1 for spraying a marker liquid.

22. The spray device according to claim 1, wherein the liquid is sprayed from the device by introducing gas into the reservoir of the spray device and forcing the liquid out of the reservoir outlet.

23. (canceled)

24. (canceled)

25. (canceled)

26. (canceled)

27. (canceled)

28. (canceled)

29. (canceled)

30. (canceled)

31. (canceled)

32. (canceled)

33. (canceled)

34. (canceled)

35. (canceled)

36. The spray device according to claims 1, wherein the spray device is included in a security system which further includes a sensor wherein the spray device is configured to spray a liquid from the reservoir in response to an event detected by the sensor.

37. (canceled)

38. (canceled)

39. The spray device according to claims 1, wherein the spray device is contained in an interior of a portable container.

40. (canceled)

41. (canceled)

42. (canceled)
